(19) United States
(12) Patent Application Publication
(10) Pub. No.: US 2012/0205019 A1
(43) Pub. Date: Aug. 16, 2012

(54) Tire Carcass Having Pattern Coated Stabilizing Fabric

(76) Inventors: Dany F. Michiels, Haaltert (BE); Franck Catteau, Marquette lez Lille (FR); Willy Delanoy, Drongen (BE); Johann Peschek, Gent (BE); Peter Eeckhout, Gent (BE)

(21) Appl. No.: 13/027,487

(22) Filed: Feb. 15, 2011

(51) Int. Cl. B60C 9/02; B29D 30/16

(52) U.S. Cl. 152/548; 156/133

(57) ABSTRACT

A pneumatic tire carcass having at least one ply of stabilizing fabric. The stabilizing fabric has a machine direction and a cross machine direction. A plurality of high tenacity reinforcing yarn elements are disposed in the cross-machine direction. A plurality of machine direction yarn elements of relatively lower tenacity than the reinforcing yarn elements are disposed in the machine direction. The stabilizing fabric has an adhesion layer on both sides of the stabilizing fabric and a patterned coating of a tackifing material overlaying a portion of at least one side of the stabilizing fabric. A segment of the stabilizing fabric is disposed within the carcass with the machine direction yarn elements being in substantial alignment with the direction of tire rotation and with the cross-machine direction oriented radially relative to the direction of tire rotation.

### TECHNICAL FIELD

The present disclosure relates generally to pneumatic tires and in particular to the construction of ply tires with a fiber-reinforced carcass containing a patterned coating.

### BACKGROUND

Typically, tires are manufactured from a single or multi-ply carcass of substantially U-shaped cross section having metal beads at the inner perimeters of the walls. Support can be provided to a tire carcass by steel cord belt plies extending around the outer periphery of the carcass and across the width of the tread. Typically, the carcass is formed from segments of rubberized woven fabric having relatively inextensible reinforcing cords running transversely, i.e. radially, from bead to bead.

In typical prior constructions, the tire carcass which acts to hold pneumatic pressure when the tire is inflated is formed from one or more plies of fabric stabilizing material which is treated with an RFL (Resorcinol Formaldehyde Latex) adhesive or the like and calendered to a rubber layer. The stabilizing fabric provides dimensional stability while the rubber provides gas containment properties. In such prior constructions the rubber functions as a carrier which can be bonded to an inner liner of rubber or the like. The carrier rubber in the calendered ply may have a mass which is several times that of the fiber forming the fabric reinforcement.

A tire carcass is required to have substantial strength in the radial direction running from bead to bead transverse to the direction rotation during use. To provide this strength, the fabric stabilizing material (also known as tire cord) has typically been a woven fabric with substantially inextensible pre-stressed high tenacity yarns running in the warp direction (also known as the “machine direction”) which are drawn and tensioned during the fabric formation and/or finishing process. This fabric is then cut in the cross-machine direction (i.e. transverse to the warp yarns). Individual pieces of the fabric are then rotated 90 degrees and are assembled to one another for placement in the carcass such that the high strength warp yarns are oriented in the desired radial direction between the beads. Thus, in the final construction, the weft yarns are oriented substantially circumferentially (i.e. in the direction of tire rotation.)

The existing carcass stabilizing materials with high strength warp yarns running in the radial direction are believed to provide adequate performance. However, the need to cut the fabrics along the cross-machine direction and to then rotate those fabrics to the desired orientation and assemble them together gives rise to substantial limitations in efficiency. In particular, in the prior practice, the use of tape or other joining techniques is required to produce a fabric length sufficient for providing to the calendar, resulting in a series of splices through the application of tape or other joining techniques. Therefore, depending on the distance between the splices and the diameter of the particular tire being made, additional splices may be present on the tire in addition to any splices formed during the tire building process itself (i.e. typically a single splice.). Moreover, the practice of calendering such fabric to a rubber carrier material tends to add substantial weight which is not desirable and can cause the build-up of heat during use.

Technical difficulties have been encountered in incorporating fabrics into the rubber goods that need reinforcement. One of the difficulties lies in ensuring good adhesion between the natural or synthetic yarns and the rubber. In tires, the centrifugal force of the steel belts can cause difficulty in the adhesion of the belt within the tire.

One solution has been to coat the stabilizing fabrics with a tackifing material.

While tackifing chemistries decrease the delamination between fabrics and the rubber and help with tack during manufacturing, too much of the tackifing chemistry could possibly have deleterious effects on the final product. Thus, it is desirable to reduce the amount of tackifing in rubber reinforced goods such as tires and hoses while maintaining enough tack for manufacture.

### BRIEF SUMMARY

According to one exemplary embodiment, the present invention provides advantages and alternative over the prior art by providing a tire including a pneumatic tire carcass having at least one ply of stabilizing fabric referred to herein as “carcass stabilizing fabric” or “body cloth”. The carcass stabilizing fabric has a machine direction and a cross machine direction. A plurality of high tenacity reinforcing yarn elements is disposed in the cross-machine direction.

According to one exemplary practice, the reinforcing yarn elements in the cross-machine direction may be pre-stretched to impart desired orientation and strength characteristics. The carcass stabilizing fabric also may be stretched in the cross-machine direction following formation to impart desired strength characteristics. Of course, combinations of such stretching treatments may also be used if desired. The reinforcing yarn elements in the cross-machine direction are be pre-treated with an adhesion layer (such as an RFL or other chemical treatments) by dip coating or the like prior to fabric formation if desired. A pattern coating of a tackifing material is then applied to the fabric over the adhesion layer. A plurality of machine direction yarn elements of relatively lower tenacity and decitex rating than the reinforcing yarn elements are disposed in the machine direction. A segment of the carcass stabilizing fabric is disposed within the carcass with the machine direction yarn elements being continuous along the carcass with the machine direction of the stabilizing fabric in alignment with the direction of tire rotation and with the cross-machine direction oriented radially relative to the direction of tire rotation.

### BRIEF DESCRIPTION OF THE DRAWING(S)

Exemplary embodiments will now be described by way of example, with reference to the accompanying drawings, wherein:

FIG. 1 is a cut-away partial view of a pneumatic radial tire illustrating one exemplary embodiment with a weft insertion body cloth to provide stability in the carcass;

FIG. 2 is a face view of a segment of a first exemplary warp-knit weft inserted fabric construction for use as a stabilizing fabric in a tire carcass;

FIG. 3 is a face view of a segment of a second exemplary warp-knit weft inserted fabric construction for use as a stabilizing fabric in a tire carcass;

FIG. 4 is a back view of the segment of warp-knit, weft inserted fabric construction of FIG. 3;

FIG. 5 is a schematic pattern view illustrating a pattern for placement of machine direction yarns in a warp-knit, weft inserted fabric construction incorporating stabilizing yarns for placement in bead zones of the tire carcass;

FIG. 6 is a schematic of a top view of stabilizing fabric having a discontinuous dot pattern of a tackifing material on surface of the stabilizing fabric over the adhesion layer;

FIG. 7 is a schematic of a top view of the stabilizing fabric having a discontinuous pattern of random areas of a tackifing material on surface of the stabilizing fabric over the adhesion layer;

FIG. 8 is a schematic of a top view of the stabilizing fabric having a grid pattern of a tackifing material on surface of the stabilizing fabric over the adhesion layer;

FIG. 9 a schematic of a top view of the stabilizing fabric having pattern of a series of parallel lines of a tackifing material on surface of the stabilizing fabric over the adhesion layer;

FIG. 10A is a schematic of a side view of a stabilizing fabric showing the discontinuous pattern of a tackifing material on surface of the stabilizing fabric over the adhesion layer;

FIG. 10B is a schematic of a side view of a stabilizing fabric showing the discontinuous pattern of a tackifing material on surface of the stabilizing fabric over the adhesion layer; and

FIG. 11 is a schematic of a side view of a pattern coated stabilizing fabric showing the discontinuous pattern of tackifing material on surface of the fabric over the adhesion layer, where the pattern coated stabilizing fabric is embedded into rubber; and

FIG. 12 is a schematic of a top view of the stabilizing fabric having pattern of dots of varying density across the stabilizing fabric of a tackifing material on surface of the stabilizing fabric over the adhesion layer.

Before embodiments are explained in detail, it is to be understood that the invention is in no way limited in its application to the details of construction and/or the arrangements of the components set forth in the following description or illustrated in the drawings. Rather, the invention is capable of other embodiments and of being practiced or carried out in various ways. Also, it is to be understood that the phraseology and terminology used herein are for purposes of description only and should not be regarded as limiting. The use herein of “including”, “comprising”, and variations thereof is meant to encompass the items listed thereafter and equivalents, as well as additional items and equivalents thereof.

### DETAILED DESCRIPTION

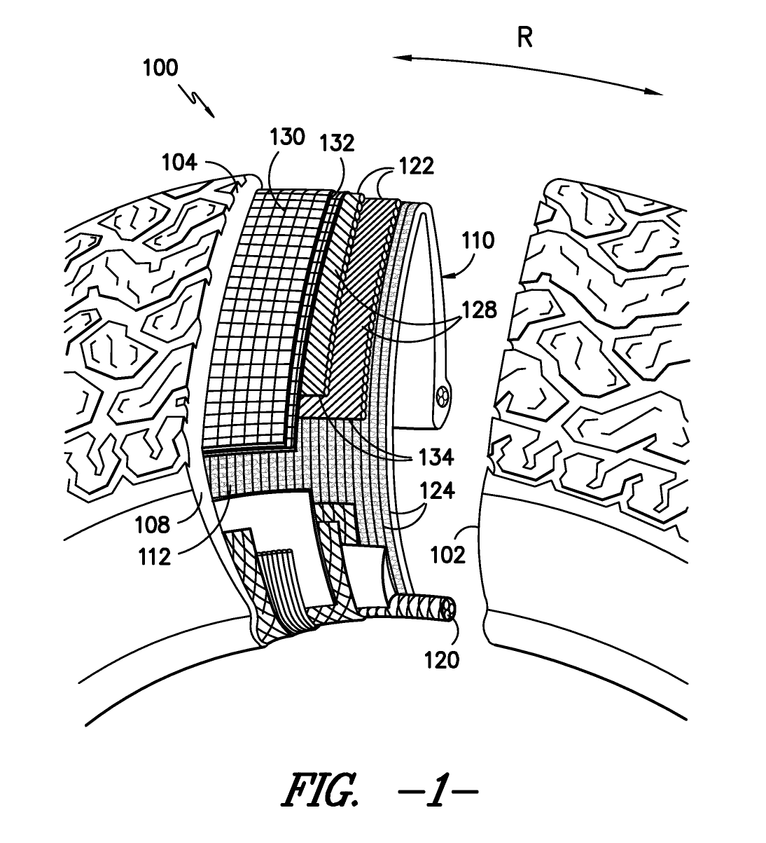

Reference will now be made to the drawings, wherein to the extent possible, like elements are designated by like reference numbers in the various views. In FIG. 1 there is shown a tire 100, comprising side walls 102 joined to a tread 104 by shoulders 108. The tire 100 includes a carcass 110 covered by the tread 104. In FIG. 1, the tire 100 is a radial tire. However, the present disclosure is not limited to radial tires and can also be used with other tire constructions. In the exemplary construction, the carcass 110 is formed from one or more plies of carcass stabilizing fabric 112 extending between metal beads 120 disposed along the inner periphery of the tire 100. The carcass stabilizing fabric 112 is disposed in overlying relation to an inner liner of rubber or the like either with or without intermediate layers of rubber or other material compatible with the inner liner. Where the carcass is to be used to form a tubeless tire, the inner liner may desirably be formed from a gas-blocking material. In another aspect of the invention where the carcass is to be used in the formation of a tubed tire, the inner liner may be formed from a gas-blocking or non-gas-blocking material. One or more belt plies 122 may be positioned circumferentially around the carcass stabilizing fabric 112 in sandwiched relation between the carcass stabilizing fabric 112 and the tread.

In accordance with one exemplary embodiment, the carcass stabilizing fabric 112 is a tackified warp knit, weft inserted fabric having weft insertion yarns formed from relatively inextensible reinforcing cords 124. Alternatively, the carcass stabilizing fabric 112 may be a woven fabric having weft yarns formed from relatively inextensible reinforcing cords or a laid scrim. The carcass stabilizing fabric 112 is embedded in or otherwise adjoined to an inner liner of rubber or other material either with or without an intermediate layer. The inner liner may be a gas-blocking matrix material if desired. By way of example only, exemplary materials forming the inner liner may include halobutyl rubber (chlorinated or brominated), NBR, SBR, EPDM, poly-butyl rubber, natural rubber, polyurethane and the like. In the tire 100 shown in FIG. 1, the carcass 110 is constructed such that that the weft inserted reinforcing cords 124 run substantially radially of the intended direction of rotation “R” of the tire 100. The belt plies 122 are formed with relatively inextensible warp materials 128 such as steel cord reinforcing warps, which run in the intended direction of rotation of the tire or, more usually, at a slight angle thereto. The angle of the inextensible warp materials 128 can vary with the method of construction of application.

In the illustrated construction, a cap ply layer 130 is located between the belt plies 122 and the tread 104. According to one exemplary construction, the cap ply layer 130 is formed from a weft inserted warp knit fabric tape 132 wound around the carcass stabilizing 112 in the rolling direction of the tire. In the embodiment illustrated, the fabric tape 132 extends over the edges 134 of the belt plies 132. Additionally, the fabric tape 132 in FIG. 1 can be wound around the carcass stabilizing 112 a plurality of times to reduce the unbalancing effect in the tire 100 caused by the overlap splice. The fabric tape also may be wound circumferentially around the carcass of the tire 100 in a flat helical pattern if desired. By way of example only, and not limitation, exemplary materials for formation of the cap ply layer 130 as well as other details of construction of a tire are set forth in U.S. Pat. No. 7,614,436 the contents of which are incorporated herein by reference in their entirety.

Referring jointly to FIGS. 1, 2 and 5, an exemplary carcass stabilizing fabric 112 of warp knit, weft inserted construction generally comprises a set of weft inserted reinforcing cords 124 and a set of high-stretch machine direction yarn elements 142 forming a repeating wale stitch pattern. In this regard, by the term “high-stretch yarn elements” is meant yarn elements characterized by an elongation at break of greater than about 30%. The high-stretch machine direction yarn elements define a stretchable fabric zone 144 for disposition across the central portion of the carcass inboard from the beads 120. In the illustrated configuration, an optional set of low-stretch machine direction yarn elements 150 of lower stretch character relative to the first machine direction yarn elements 142 form a repeating wale stitch pattern to define a low stretch reinforcement zone 156 to provide additional support at locations adjacent to the beads 120. In this regard, by the term “low-stretch yarn elements” is meant yarn elements characterized by an elongation at break of not greater than about 30%. As shown, in the illustrated exemplary construction, both the high-stretch yarn elements 142 and the low-stretch yarn elements 150 are formed in a so called “pillar stitch” although other stitching arrangements may be used if desired including chain stitches, tricot stitches leno weaves or the like.

By way of example only, and not limitation, FIG. 5 schematically illustrates one pattern for placement of the high-stretch yarn elements 142 defining stretchable fabric zones 144 and the low-stretch yarn elements 150 defining a reinforcement zone 156. As will be appreciated, while only a single reinforcement zone 156 is shown, the illustrated pattern may be repeated across the fabric multiple times such that each of the stretchable fabric zones 144 is bordered on either side by a low-stretch reinforcement zone 156. Thus, by cutting the fabric in the machine direction at the interior of the reinforcement zones 156, multiple panels may be produced with each panel including an interior stretchable fabric zone 144 with a reinforcement zone on either lateral edge.

The spacing between reinforcement zones 156 may be set to accommodate a given tire size such that the reinforcement zones 156 are in the desired position adjacent the beads 120 or in such other locations as may be desired. As shown, in the illustrated arrangement the reinforcement zone 156 is made up of a pair of edge reinforcement segments 164 on either side of a core reinforcement segment 166. By way of example only, each of the edge reinforcement segments 164 may have a width of about 1 cm and the core reinforcement segment 166 may have a width of about 1 centimeter. However, these widths may be adjusted as desired. As illustrated, the packing density (ends per centimeter) of the machine-direction yarns elements may be adjusted to provide desired character across the fabric. By way of example only, according to one embodiment the low-stretch yarn elements 150 are 235 decitex standard nylon 6,6 yarns which are present at a packing density of about 4.3 ends per centimeter in the core reinforcement segment 166 and at a packing density of about 2.16 ends per centimeter in the edge reinforcement segments 164. The high-stretch yarn elements 142 are 78 decitex/3 (234 decitex total) partially oriented nylon 6,6 present at a packing density of about 0.86 ends per centimeter in the stretchable fabric zones 144. Thus, when the fabric is segmented, the concentration of yarns in the machine direction is greater along the edges than at the interior. Moreover, the machine direction yarn elements at the edges are low-stretch yarns thereby providing additional stability at the edges.

In one exemplary embodiment, the high-stretch machine direction yarn elements 142 are characterized by an elongation at break of about 30% to about 200% and more preferably about 60% to 150% and most preferably about 60% to 100% such that they can stretch a controlled amount during tire formation. Preferably, the optional low-stretch machine direction yarn elements 150 are characterized by an elongation at break of about 5%-25% and more preferably about 10% to about 22% and most preferably about 15% to 20% such that the reinforcement zones 156 exhibit very limited stretch during tire formation and use. The percentage elongation at break of the high-stretch machine direction yarn elements 142 is preferably about 1.5 to 6 times greater than the percentage elongation at break of the low-stretch yarn elements 150 and more preferably about 2 to 5 times greater than the percentage elongation at break of the low-stretch machine direction yarn elements 150 and most preferably about 3 to 5 times greater than the percentage elongation at break of the low-stretch machine direction yarn elements 150.

The wales formed by the high-stretch yarn elements 142 and the low-stretch yarn elements 150 extend along the so-called warp or “machine direction” of the carcass stabilizing fabric 112. The weft inserted reinforcing cords 124 run in the so-called weft or “cross-machine direction” of the carcass stabilizing fabric 112. As will be appreciated, the machine direction of a fabric is the direction substantially aligned with the output of the formation machine used to produce the fabric. Conversely, the cross-machine direction is the direction extending across the width of the formation machine.

By way of example only, the carcass stabilizing fabric 112 can be produced in a weft inserted warp knit machine which is wider and faster than a traditional weaving machine. The weft inserted warp knit machine further stabilizes the fabric with the reinforcing cords 124 inserted in chosen loops of the machine direction yarn elements 142, 150. Slitting between the wales in the machine direction can be done with limited de-knitting or fraying.

As will be appreciated, by cutting the carcass stabilizing fabric in the machine direction, a fabric segment of virtually any length may be obtained. Thus, the carcass stabilizing fabric 112 may extend circumferentially about the carcass as a unitary structure without intermediate breaks along the length resulting from splices of the stabilizing fabric, other than those used in the tire building process itself, and with the machine direction of the fabric generally aligned with the direction of rotation. In this arrangement, the reinforcing cords 124 in the cross-machine direction are oriented in the radial direction transverse to the direction of rotation. The construction material, size, and spacing of the reinforcing cords 124 and machine direction yarn elements 142, 150 are selected such that they provide the desired strength to the carcass 110.

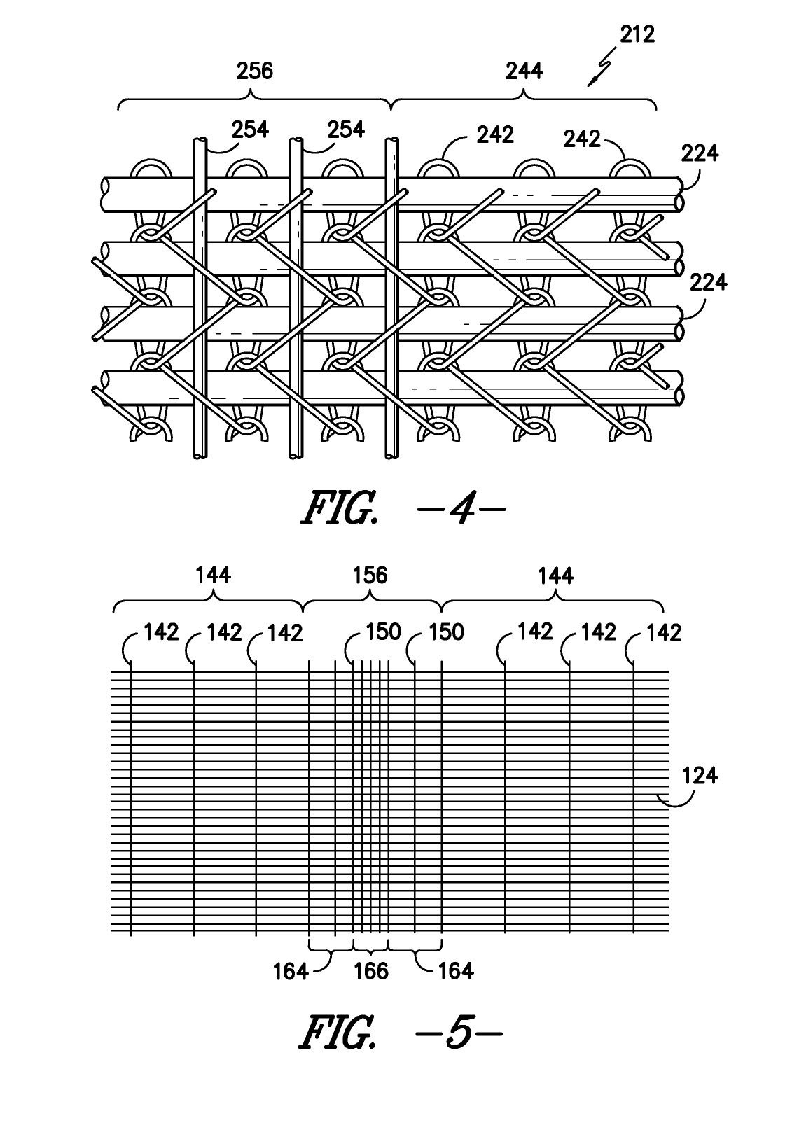

An alternative embodiment for a carcass stabilizing fabric 212 is shown in FIGS. 3 and 4. In these figures, elements corresponding to those previously described are designated by like reference numerals within a 200 series. Specifically, FIG. 3 shows the front face (on the knitting machine) of the carcass stabilizing fabric 212 and FIG. 4 shows the back face (on the knitting machine) of the same carcass stabilizing fabric 212. As shown, this exemplary embodiment includes high-stretch machine direction yarn elements 242 disposed in a tricot stitch pattern or other suitable stitch pattern throughout the fabric with a plurality of stabilizing in-lay warp yarns 254 running in the machine direction at localized reinforcement zones 256 across the fabric. As shown, the in-lay warp yarns 254 are arranged within reinforcement zone 256 where added strength and stretch resistance may be desired. By way of example only, and not limitation, such in-lay warp yarns 254 may be arranged in a reinforcement zone 256 which will be adjacent to the beads 120 in the final tire construction. Exemplary in-lay warp yarns include spun staple yarns, multifilament yarns, and/or monofilament yarns and are formed of a material which will restrain the carcass in the warp direction. Some suitable materials for in-lay warp yarns include polyamide, aramides (including meta and para forms), rayon, PVA (polyvinyl alcohol), polyester, polyolefin, polyvinyl, nylon (including nylon 6, nylon 6,6 and nylon 4,6), polyethylene napthalate (PEN), polyethylene terephalate (PET), cotton, polyacrylic or other known artificial or natural fibers. One exemplary material for such in-lay warp yarns is a 235 detx partially oriented Nylon 6,6 although other materials may also be used.

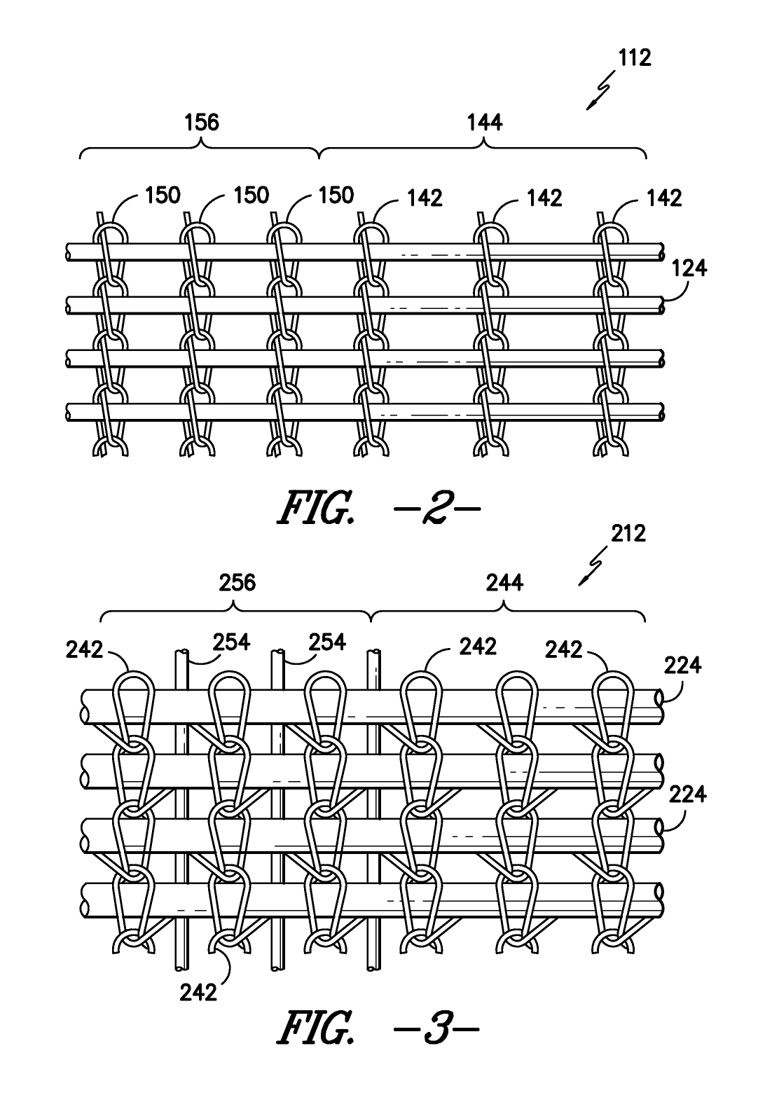

According to one exemplary practice, the reinforcing cords 124, 224 may be inserted in each stitch. By way of example only, FIGS. 2 and 3 show the front faces (on the knitting machine) of carcass stabilizing weft inserted fabrics 112, 212 with the reinforcing cords 124, 224 inserted at every stitch. However, the reinforcing cords 124, 224 may likewise be inserted in a repetitive construction, for example one weft in every 2 stitches, one weft in every 3 stitches, one weft in every 4 stitches, etc. The reinforcing cords 124, 224 also may be inserted in a pattern, for example one weft in every stitch for 2, 3, 4, 5, etc. stitches followed by 1, 2, 3, 4, 5, etc. stitches with no weft inserted reinforcing cords.

The reinforcing cords 124, 224 can be a spun staple yarn, a multifilament yarn, and/or a monofilament yarn and are formed of a material which will restrain the carcass in the radial direction. Some suitable materials for reinforcing cords include polyesters (e.g., polyethylene terephthalate, polypropylene terephthalate, polybutylene terephthalate, polylactic acid, and polyethylene napthalate (PEN)), polyolefins (e.g., polyethylene and polypropylene), polyamides (e.g., nylon 6, nylon 6,6, nylon 4,6, and nylon 12), aramides (including meta and para forms), rayon, PVA (polyvinyl alcohol), cotton, carbon, fiberglass, polyacrylic or other known artificial or natural fibers. In one embodiment, the reinforcing cords 124, 224 may be multifilament twisted and/or cabled cords of two or more plies made with any of the prior listed materials or combinations thereof. In one embodiment, the reinforcing cords 124, 224 may be between 100 decitex (90 denier) up to 23,500 decitex (21,000 denier) and more preferably about 230 to 5000 decitex made with single or multiple yarns. The reinforcing cords 124, 224 preferably are characterized by low stretch of not greater than 30% elongation at break and more preferably about 0 to 20% elongation at break.

By way of example, reinforcing cords 124, 224 may be standard HMLS polyester with two cabled plies having constructions of 1670/2 (3340 decitex); 1440/2 (2880 decitex); or 1100/2 (2200 decitex). The fibers forming the reinforcing cords 124, 224 may be pre-treated by drawing to substantially eliminate stretch in the final yarn and are treated with an adhesion promoter such as RFL or the like prior to fabric formation. The reinforcing cords 124, 224 may also be subjected to stretching to impart added strength after fabric formation. Such post-formation stretch treatment may be conducted alone or in combination with stretching prior to fabric formation.

The high-stretch yarn elements 142, 242 can be made of natural and manmade fibers including polyesters (e.g., polyethylene terephthalate, polypropylene terephthalate, polybutylene terephthalate, and polylactic acid), polyolefins (e.g., polyethylene and polypropylene), polyamides (e.g., nylon 6, nylon 6, 6, nylon 4, 6, and nylon 12), and any combination thereof or any other known synthetic technical raw material or artificial or natural fibers. By way of example, the high-stretch yarn elements 142, 242 may be made with any single monofilament or multifilaments yarn as well as any multi-ply twisted yarns made with any of the prior listed materials. In accordance with one embodiment, the high-stretch yarn elements 142 may have a linear density between 22 decitex (20 deniers) up to 470 decitex (420 deniers) also in single yarn or multi-ply yarns. Such yarns may have a twist level of about 150 to about 1200 turns/meter (preferably 400-800 turns/meter). One such yarn that may be desirable is a 78 decitex/3 (234 decitex total) partially oriented nylon 6,6 with a twist of about 600 turns/meter and an elongation at break of about 78%. However, other materials may likewise be used if desired.

The optional low-stretch machine direction yarn elements 150 forming the reinforcement zones 156 can be a spun staple yarn, a multifilament yarn, and/or a monofilament yarn and are formed of a material which will restrain the carcass in the circumferential direction. Some suitable materials for the low-stretch machine direction yarn elements 150 include polyesters (e.g., polyethylene terephthalate, polypropylene terephthalate, polybutylene terephthalate, and polylactic acid), polyolefins (e.g., polyethylene and polypropylene), polyamides (e.g., nylon 6, nylon 6,6, nylon 4,6, and nylon 12), aramides (including meta and para forms), rayon, PVA (polyvinyl alcohol), polyethylene napthalate (PEN), cotton, carbon, fiberglass, polyacrylic or other known artificial or natural fibers. In one embodiment, the low-stretch machine direction yarn elements 150 may be multifilament twisted and/or cabled cords of two or more plies made with any of the prior listed materials or combinations thereof. In accordance with one embodiment, the low-stretch machine direction yarn elements 150 may be between 111 decitex (100 deniers) up to 700 decitex (630 deniers) also in single yarn or multiple yarns. Such yarns may have a twist level of about 150 to about 1200 turns/meter (preferably 400-800 turns/meter). One such yarn that may be desirable is a three ply 235 decitex partially oriented nylon 6,6 yarn with elongation at break of about 19%. However, other materials may likewise be used if desired.

Any of the yarn elements may also be hybrid yarns. These hybrid yarns are made of up of at least 2 fibers of different fiber material (for example, cotton and nylon). These different fiber materials can produce hybrid yarns with different chemical and physical properties. Hybrid yarns are able to change the physical properties of the final product they are used in. Some preferred hybrid yarns include an aramide fiber with a nylon fiber, an aramide fiber with a rayon fiber, and an aramide fiber with a polyester fiber.

In accordance with one exemplary formation practice, the reinforcing cords 124, 224 are formed from one or more plies of suitable polymeric fiber such as HMLS polyester twisted to about 100 to about 800 turns per meter, more preferably about 200 to about 600 turns per meter, most preferably about 250 to about 500 turns per meter to form a cohesive yarn structure. The linear density of the reinforcing cords 124, 224 is in the range of about 230 decitex to about 5000 decitex, more preferably about 1500 decitex to about 4000 decitex, and most preferably about 2000 to about 3500 decitex. The fibers forming the reinforcing cords 124, 224 may be pre-treated by drawing to substantially eliminate stretch in the final yarn and are treated with an adhesion promoter such as VP latex based RFL or the like prior to fabric formation. The reinforcing cords 124, 224 are inserted as the weft component in a warp knit, weft insertion fabric. The packing density of the reinforcing cords 124, 224 is in the range of about 80 to about 140 ends per decimeter, more preferably about 95 to about 120 ends per decimeter, most preferably about 105 to about 115 ends per decimeter. The reinforcing cords 124, 224 extend through loops formed by warp-knit, high-stretch yarn elements 142 having a linear density of between 122 decitex and about 470 decitex with a twist level of about 150 to about 1200 turns/meter and an elongation at break of at least 30%. The resultant fabric is characterized by a braking strength in the weft direction of at least 170 Newtons (e.g. greater than 173 Newtons, greater than 181 Newtons, greater than 186 Newtons). At 45 Newtons, the resultant fabric is characterized by an elongation in the weft direction of less than 5% (e.g. less than 4%, less than 3.5%). At 53 Newtons, the resultant fabric is characterized by an elongation in the weft direction of less than 7% (e.g. less than 6.5%, less than 5%). At 67 Newtons, the resultant fabric is characterized by an elongation in the weft direction of less than 7% (e.g. less than 6.5%, less than 5%). The resultant fabric exhibited adhesion peel strength of greater than 100 Newtons per 25 mm (e.g. greater than 120 Newtons per 25 mm) relative to underlying rubber. The resultant fabric was characterized by hot air shrinkage of less than 3% (e.g. not greater than 2.8%, not greater than 2.5%, not greater than 1.8%),

While the carcass stabilizing fabric 112 is illustrated as being a warp knit, weft insertion fabric, it is also contemplated that the carcass stabilizing fabric 112 may be a woven fabric if desired. Such fabrics may be formed by techniques such as air jet weaving, water-jet weaving, or rapier weaving as will be known to those of skill in the art. In this regard, rapier weaving may be desirable for use with high decitex reinforcing cords. By way of example only, and not limitation, an exemplary woven fabric may be a so called “plain weave” or “twill weave” fabric in which reinforcing cords 124 as previously described are disposed along the weft direction. In such a construction, the warp yarns may be formed from materials similar to the stitching yarns 142 in the warp knit weft insertion construction. It is also contemplated that the carcass stabilizing fabric 112 may be in the form of a laid scrim or the like if desired.

A frequent problem in making a rubber composite is maintaining good adhesion between the rubber and the stabilizing fabric. A conventional method in promoting the adhesion between the rubber and the reinforcement is to pretreat the reinforcing yarn with an adhesion layer of a mixture of rubber latex and a phenol-formaldehyde condensation product wherein the phenol is almost always resorcinol. This is the so called “RFL” (resorcinol-formaldehyde-latex) method.

The reinforcing cords 124, 224 or the stabilizing fabric 112, 212 may be dip coated or otherwise treated with an adhesion promoter to form an adhesion layer prior to fabric formation to improve the adhesion with any other material to be reinforced (as for example, without any limitation: rubber material, PVC coating material, etc). Typical examples of adhesion promoters included Resorcinol Formaldehyde Latex (RFL) as well as formaldehyde free materials such as isocyanate based material, epoxy based material, and materials based on melamine formaldehyde resin. In one embodiment, the adhesion promoter is formaldehyde-free. The adhesion promoter may be applied prior to or subsequent to fabric formation (to form the adhesion layer), such as by dip coating or other application method. Generally, the adhesion layer is applied by dipping the fabric or yarns in a RFL solution. The coated fabric or yarns then pass through squeeze rolls and a drier to remove excess liquid. The adhesion layer usually is cured at a temperature in the range of 150° to 200° C. The resorcinol-formaldehyde latex (RFL) can contain vinyl pyridine latexes, styrene butadiene latexes, waxes, fillers and other additives. The adhesion layer is typically located on both sides of the stabilizing fabric 112 and may partially or fully penetrate the fabric and its interstices.

The carcass stabilizing fabric 112, 212 may also have a tackified material applied for facilitating adhesion, or green tack, during the building process of the green tire on top of the adhesion layer. This may eliminate the need for calendering the stabilizing fabric to a rubber carrier during the tire-building process. However, calendering to a carrier of rubber or other material may be used if desired.

The selection of materials for the tackifing material will depend upon the materials selected for use in the tire, and the skilled person on the basis of his common knowledge can easily determine them appropriately. Tackified finishes can be achieved by various methods such as coating the fabric in an aqueous blend of rosin or crude oil residue and rubber lattices, or with a solvent solution of an un-vulcanized rubber compound. Typical examples of tackifing materials include mixtures containing resorcinol formaldehyde latex (RFL), isocyanate based material, epoxy based material, rubber, PVC, and materials based on melamine formaldehyde resin.

As noted previously, the practice of calendering the stabilizing fabric to a rubber carrier for subsequent connection to an underlying inner layer may tend to add a fairly significant additional mass of rubber to the final construction. Specifically calendering a stabilizing fabric to a rubber carrier typically yields a reinforced ply having a mass which is at least 300% of the mass of fiber in the reinforced ply. The stabilizing fabrics may be operatively connected to the inner liner either with or without calendering to a carrier as a preliminary step. In the event that calendering to a carrier is not utilized, the tackifing materials and other materials applied to the stabilizing fabric may be present at relatively low add-on levels. In this regard, in accordance with one exemplary embodiment, the mass of the stabilizing fabric ply including any applied materials may be less than about 170% of the mass of fiber constituents in the stabilizing fabric ply. Thus, the overall mass of rubber in the tire is reduced. Such a reduction may be desirable in some circumstances.

The elimination of calendering to a carrier layer may also provide the further advantage of permitting the stabilizing fabric to stretch independently of any constraining material, such as with a layer of calendered rubber. Thus, the stretch characteristics of the stabilizing fabric may be controlled with greater precision through the selection of materials and construction techniques without influence from an applied carrier layer.

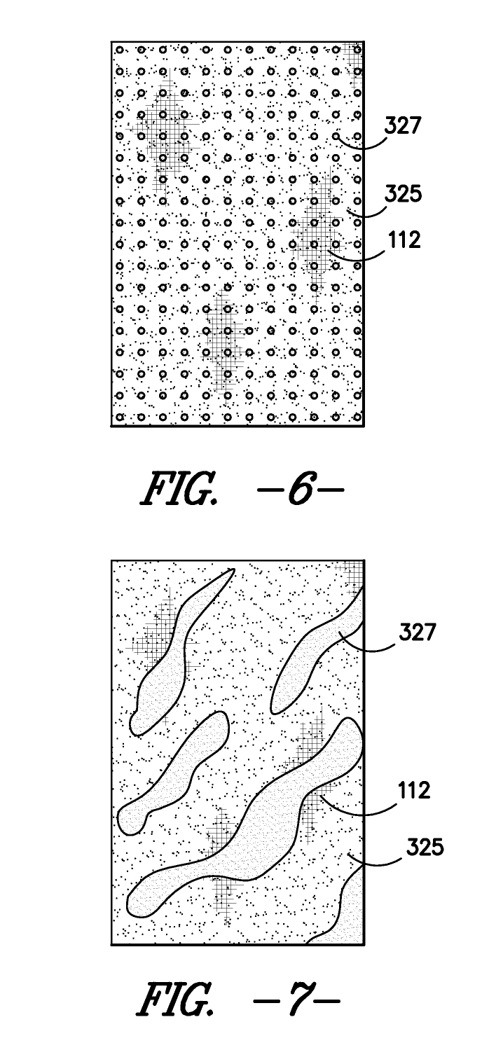

In one embodiment, the carcass stabilizing fabric 112, 212 contains a patterned coating of a tackifing material over the adhesion layer. Referring now to FIG. 6, there is shown one embodiment for the coated stabilizing fabric 112 where an adhesion layer 325 is on both the first and second sides of the fabric 112, and a patterned coating 327 of a tackifing material is on at least one side of the fabric 112 overlaying at least a portion of the adhesion layer 325.

The patterned coating 327 may be on one or both sides (first and/or second) of the fabric 112 over the adhesion layer 325. The two sides may have the same pattern or different patterns and the patterns may or may not be registration with one another. In one embodiment, the tackifing material is placed on one side of the fabric over the adhesion layer in a patterned coating and on the other side, the tackifing material may be placed as a continuous non-patterned coating. The patterned coating 327 provides for optimum greentack while minimizing the amount of the adhesion layer that is covered up and minimizes the amount of rubber or other adhesion promoters in the tire. While the patterned coating 327 is shown as applied to the fabric, a patterned coating of tackifing material may also be applied to the yarns before fabric formation.

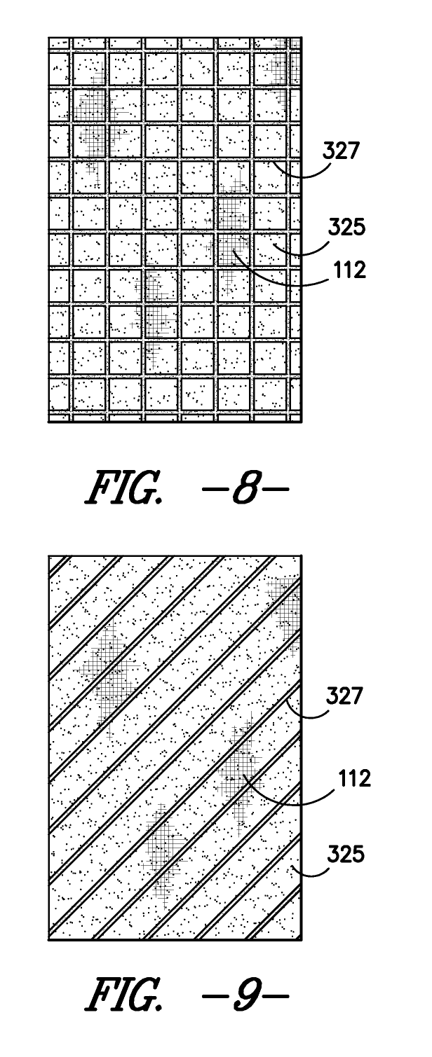

The patterned coating 327 may be continuous or discontinuous, regular and repeating or random. “Continuous” in this application means that from one edge of the fabric to the other edge there is a continuous path that contains the patterned coating and that at least some of the patterned coating areas are connected. Examples of continuous coatings include FIGS. 8 and 9. “Discontinuous” in this application means that the pattern coated areas are discontinuous and not touching one another. In a discontinuous patterned coating, there is no path from one edge of the fabric to the other that contains the patterned coating. Examples of discontinuous coatings include FIGS. 6, 7, and 12. Regular or repeating patterns mean that the pattern has a repeating structure to it. FIGS. 6, 8, 9, and 12 illustrate repeating or regular patterns. FIG. 7 illustrates a random pattern where there is no repeat to the patterned coating. In a random pattern, it is preferred that the random pattern is also discontinuous, not continuous.

FIG. 6 illustrates the embodiment where the patterned coating 327 is in a dot pattern. This pattern is discontinuous and repeating. The dots may be equally spaced on the fabric, or may have differing densities of dots or sizing of dots across the surface of the fabric. FIG. 7 illustrates the embodiment where the patterned coating 327 is in random, discontinuous spotting pattern. FIG. 8 illustrates the embodiment where the patterned coating 327 is in a grid. This pattern is regular and continuous. FIG. 9 illustrates the embodiment where the patterned coating 327 is in a series of parallel lines. This pattern is also regular and continuous. The patterned coating 327 may take any other patterned form including but not limited to indicia, geometric shapes or patterns, and text.

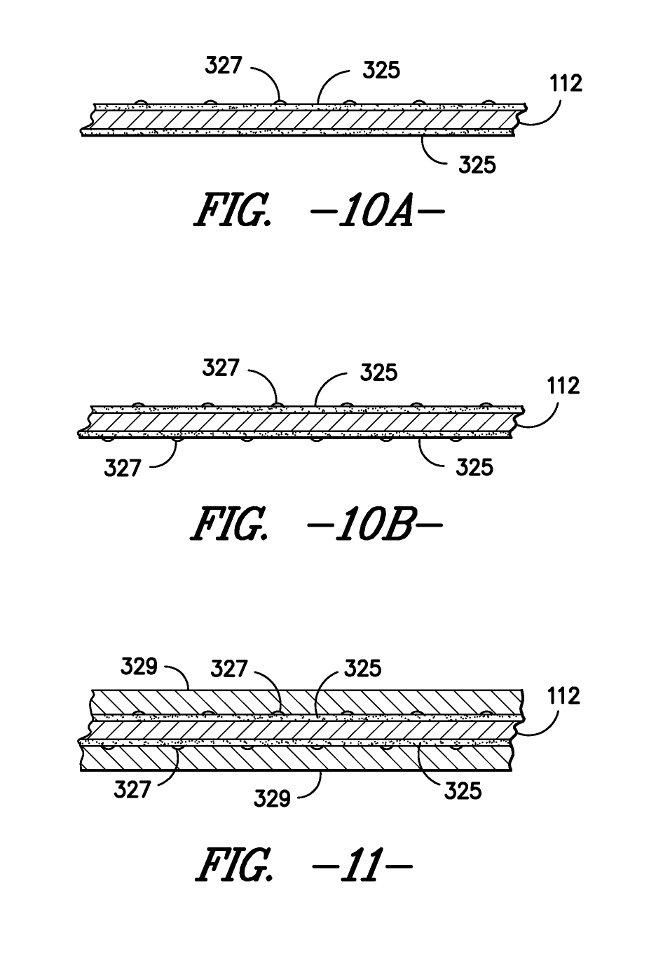

FIGS. 10A and 10B illustrate side views of the coated stabilizing fabric illustrating the patterned coating 327 on one side of the fabric 112 over the adhesion layer 325 (7A) and both sides of the fabric 112 over the adhesion layer 325 (7B). The patterned coatings may be the same or different patterns and coverage on both sides of the cap ply. For example, the patterned coating 327 on one side of the fabric may have a regular repeating grid pattern covering 10% of the surface area while the patterned coating 327 on the opposite side of the fabric 112 may have a discontinuous repeating dot pattern covering 25% of the surface. Each surface pattern may be chosen to optimize the tire production process and article as well as desired adhesion properties between the stabilizing fabric and the layer in the tire adjacent the stabilizing fabric.

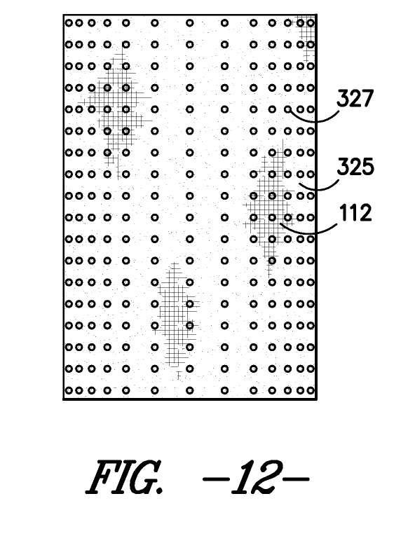

FIG. 11 illustrates the pattern coated stabilizing fabric 112 embedded into rubber 329. Preferably, the rubber 329 migrates or impregnates partially or fully the stabilizing fabric 112.

In one embodiment, the patterned coating 327 of the tackifing material is on the cross-over points in the fabric, for example where the weft and warp yarns cross in a woven fabric. In another embodiment, the patterned coating 327 of tackifing material is substantially only on the cross-over points in the fabric and not on the rest of the fabric 112.

The patterned coating 327 may be formed by any known method of forming a patterned coating including but not limited to inkjet printing, gravure printing, patterned printing, thermal transfer, spray coating, and silk printing. The thickness and/or physical composition of the patterned coating 327 may vary over the length and/or width of the cap ply tape 310. For example, it may be preferred in some embodiments to have a thicker coating or more densely packed pattern in some areas of the cap ply. This can be seen, for example, in FIG. 12 where the dot pattern of the patterned coating layer varies over the width of the fabric to have a higher amount of patterned coating covering the surface of the fabric towards the edges.

In one embodiment, the patterned coating 327 covers between about 5 and 95% of the surface area of the fabric 112 (over the adhesion layer 325). In other embodiments, the patterned coating may cover between about 5 and 70%, 10 and 60%, 45 and 75%, greater than 15%, greater than 20% and greater than 30% of the surface area of the fabric 112. In another embodiment, the patterned coating 327 has a weight of between about 5 and 60% wt of the fabric 112. In other embodiments, the patterned coating has a weight of between about 5 and 50%, 10 and 50%, 10 and 45%, 15 and 35%, greater than 15%, greater than 20% and greater than 30% of the weight of the fabric 112.

In practice, the formation of the carcass stabilizing fabric 112, 212 begins with selection of the desired yarn characteristics. As a preliminary step, the fibers for formation of the yarns are subjected to drawing to impart desired levels of strength and elongation. The fibers are then formed into yarns and may be twisted to provide additional mechanical resilience. The yarn is then treated with adhesive promoter, such as an RFL treatment to form the adhesion layer before fabric formation (the adhesion layer may also be applied to the fully formed fabric). The carcass stabilizing fabric 112 is formed in large widths, such as 61.4 inches and is then treated with the patterned coating of the tackifing material. The final fabric is slit along the machine direction into the specific widths for placement on a spool. The fabric then may be used directly or be calendered with a rubber coating for use in a tire carcass in overlying relation to an inner liner.

In the tire formation process, the tire carcass 110 is formed with the carcass stabilizing fabric 112, 212, metal beads, 120, and belt plies 122. In this regard, within the tire carcass 110, the stabilizing fabric 112, 212 may be arranged in direct contact with a halo-rubber or other inner liner material as may be utilized. Alternatively, one or more intermediate layers may be disposed between the carcass stabilizing fabric 112, 212 and the inner liner material if desired. Where more than one layer of the stabilizing fabric is to be used, it may be desirable to skim coat or calender a thin layer of rubber to the stabilizing fabric to facilitate adhesion between the layers when the tire is built. After the tire carcass is formed (and is tire shaped), the cap ply layer 130 is wound around the belt plies 122. The tread 104 is molded onto the subassembly, and the tire 100 is completed.

Thus, a process according to the invention would involve forming a fabric having a machine (e.g. warp) direction, and a cross machine (e.g. weft) direction, such as by a weaving, warp-knit, weft insertion or laid scrim manufacturing process, with the warp direction being the direction in which the fabric is manufactured and taken up from the fabric production process. In a first exemplary embodiment, at least a first plurality of yarns in the machine direction (warp yarns) have an elongation at break of 30% to 200%. In another exemplary embodiment, the weft yarns (cross-machine direction) have an elongation at break of not greater than 30%. The fabric is then desirably slit to the width desired for the particular tire to be manufactured, and optionally treated with a tacky finish or other treatment. The fabric can then be cut to the length needed to cover the full diameter of the tire drum on which the tire is being made, or it can be provided as a continuous roll which is cut to length as the carcass is being built. An inner liner is provided on a tire building drum, and the stabilizing fabric is provided on the drum such that the machine direction yarns from the fabric formation process extend around the drum such that they will be oriented in the tire in substantial alignment with the direction of tire rotation and the cross-machine direction yarns are oriented radially relative to the direction of tire rotation. In any event, because the stabilizing fabric is provided as a continuous roll of material, a continuous series of tires can be built having no splices in the tires other than those formed during the tire building process itself. Also, because the fabric does not require the layer of calendered rubber required in other conventional processes, a source of manufacturing variation can be reduced or eliminated.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A pneumatic tire carcass having strength in the radial direction, the tire carcass comprising:
an inner liner;
at least one ply of stabilizing fabric having a first and second side, the stabilizing fabric in embedded or layered relation to the inner liner, the stabilizing fabric having a machine direction and a cross machine direction, the stabilizing fabric including a plurality of weft yarns disposed in the cross-machine direction and at least a first plurality of machine direction yarn elements of relatively lower tenacity than the weft yarns disposed in the machine direction, wherein the first plurality of machine direction yarn elements have an elongation at break of 30% to 200% and wherein the stabilizing fabric is disposed within the carcass with the machine direction of the stabilizing fabric in substantial alignment with the direction of tire rotation and with the cross-machine direction oriented radially relative to the direction of tire rotation;
an adhesion layer on both the first and second side of the stabilizing fabric; and,
a patterned coating of a tackifing material on at least the first side of the stabilizing fabric overlaying a portion of the adhesion layer.

2. The pneumatic tire carcass of claim 1, wherein the adhesion layer comprises resorcinol formaldehyde latex (RFL).

3. The pneumatic tire carcass of claim 1, wherein the stabilizing fabric is selected from the group consisting of a woven fabric, a warp knit weft insertion fabric, and a laid scrim.

4. The pneumatic tire carcass of claim 1, wherein the patterned coating is discontinuous.

5. The pneumatic tire carcass of claim 1, wherein the patterned coating is continuous.

6. The pneumatic tire carcass of claim 1, wherein the patterned coating is repeating.

7. The pneumatic tire carcass of claim 1, wherein the patterned coating has a pattern selected from the group consisting of lines, a grid of lines, indicia, and discontinuous dots.

8. The pneumatic tire carcass of claim 1, wherein the patterned coating covers between about 45 and 75% of the surface area of the first side of the fabric.

9. The pneumatic tire carcass of claim 1, wherein the patterned coating covers a portion of both of the sides of the fabric.

10. A pneumatic tire carcass having strength in the radial direction, the tire carcass comprising:
an inner liner; and
a plurality of plies of stabilizing fabric, each ply having a first and second side, the plurality of plies of stabilizing fabric in embedded or layered relation to the inner liner, the stabilizing fabric having a machine direction and a cross machine direction, the stabilizing fabric including a plurality of weft yarns having an elongation at break of not greater than 30% disposed in the cross-machine direction and at least a first plurality of machine direction yarn elements of relatively lower tenacity than the weft yarns disposed in the machine direction, wherein each ply of stabilizing fabric includes machine direction yarn elements disposed in substantial alignment with the direction of tire rotation and with the cross-machine direction oriented radially relative to the direction of tire rotation;
an adhesion layer on both the first and second side of the stabilizing fabric; and,
a patterned coating of a tackifing material on at least the first side of the stabilizing fabric overlaying a portion of the adhesion layer.

11. The pneumatic tire carcass of claim 10, wherein the adhesion layer comprises resorcinol formaldehyde latex (RFL).

12. The pneumatic tire carcass of claim 10, wherein the patterned coating is discontinuous.

13. The pneumatic tire carcass of claim 10, wherein the patterned coating has a pattern selected from the group consisting of lines, a grid of lines, and discontinuous dots.

14. A process for forming a pneumatic tire comprising:
forming a stabilizing fabric having a machine direction and cross-machine direction and a first and second side, wherein the fabric is selected from the group consisting of knit, woven, and scrim, wherein the machine direction yarns are in the machine direction of the fabric and the cross-machine direction yarns are in the cross-machine direction of the fabric, and wherein the machine direction yarns have an elongation at break of between about 30 and 200%;
coating an adhesion layer on both the first and second side on the stabilizing fabric; and,
applying an tackifing material on at least a first side of the stabilizing fabric in a pattern overlaying a portion of the adhesion layer.
obtaining an inner liner for a tire;
applying the stabilizing fabric to the inner liner, wherein the machine direction of the stabilizing fabric is in substantial alignment with the direction of tire rotation and with the cross-machine direction oriented radially relative to the direction of tire rotation.

15. The process of claim 14, wherein the adhesion layer comprises resorcinol formaldehyde latex (RFL).

16. The process of claim 14, wherein the patterned coating is applied by a coating method selected from the group consisting of inkjet printing, gravure printing, thermal transfer, spray coating, and silk printing.

17. The process of claim 14, wherein the patterned coating is discontinuous.

18. The process of claim 14, wherein the patterned coating is continuous.

19. The process of claim 14, wherein the patterned coating is repeating.

20. The process of claim 14, wherein the patterned coating is random.

21. The process of claim 14, wherein the patterned coating has a pattern selected from the group consisting of lines, a grid of lines, indicia, and discontinuous dots.

22. The process of claim 14, wherein the patterned coating covers a portion of both of the sides of the stabilizing fabric.
